(19) United States
(12) Patent Application Publication
(10) Pub. No.: US 2023/0139859 A1
(43) Pub. Date: May 4, 2023

(54) AUTOMOBILE WINDSHIELD AND WINDOW SUNSHADE DEVICE AND SYSTEM

(71) Applicant: Sagar Shah, San Diego, CA (US)

(72) Inventor: Sagar Shah, San Diego, CA (US)

(21) Appl. No.: 17/980,509

(22) Filed: Nov. 3, 2022

Related U.S. Application Data
(60) Provisional application No. 63/275,877, filed on Nov. 4, 2021.

(51) Int. Cl. B60J 1/20

(52) U.S. Cl. CPC B60J 1/2091

(57) ABSTRACT

Automobile sunshade system for automobiles which does not interfere with the existing safety systems in the automobile. In one embodiment, the automobile sunshade consists of a fixed structure with a moving arm that is capable of angular rotation with respect to the fixed structure such that the sunshade unfolds the shading material and deploys the shade. The deployed shade can have multiple different support structures that control the shape of the deployed shade as well as to assist in aligning the deployment and collapsing of the shade. In another embodiment, the automobile sunshade may consist of two arms and a support bar that works with the shade material rolled on a roller spring bar, where the two arms rise and lower the support bar when the moving arms move relative to the fixed structure.

### PRIORITY

This application claims the benefit of priority to U.S. Provisional Patent Application Ser. No. 63/275,877 filed Nov. 4, 2021, of the same title, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. FIELD OF THE DISCLOSURE

The present disclosure describes a system for providing shade to the interior of an automobile from external sunlight.

### 2. DESCRIPTION OF RELATED TECHNOLOGY

The current state of the art for shading systems in practice is the use of darkened or tinted windows on the rear passenger windows and the rear windshield. In other use cases the automobile driver would typically buy a foldable reflective film that they unfold to deploy the shade and fold it back up in order to remove the shading while also minimizing the size of the reflective film for storage in the automobile, typically before driving. Typically, these foldable reflective film devices are only used for the front windshield.

For the side windows there are suction cup-based shades available which are used in some instances as semi-permanent shading systems, or fabric shades using static cling to attach the fabric shade to a respective window glass pane. These shades have the following disadvantages; first, they get hot when exposed to direct sunlight and the latent heat of the shade can heat up the automobile interior, and second, the user cannot open the window by rolling it down as the shade would interfere due to its attachment to the window.

There are also available shading sleeves which the user needs to cover the window opening by placing the sleeve over the door itself. Although it does not interfere when rolling down the window, it heats up the interior while providing shade and additionally, in case of rain, the fabric will allow the water to permeate inside based on the absorption characteristics of the fabric used.

There are also roll-able shades using suction cups available which drivers or automobile owners purchase and install on the front windshield which can be unrolled for deployment and rolled back for driving purposes.

In the current state of the art, there does not exist a shading system that can be easily deployed, removed, and stored as part of the automobile or as an additional entity. There also does not exist a shading system that is integrated with the automobile electronics that can be easily controlled by the automobile user. There also does not exist a windshield and window shading system that automatically controls the shading on all windows and windshields from a central point depending on the environmental factors, automobile engine and transmission states, or user inputs in general.

### SUMMARY

The present disclosure describes a sunshade system that solves the above problems of automobile integration, shading control and the overall user experience in general, while requiring minimal modification to the existing interior of the automobile.

In one aspect, an automobile sunshade is disclosed. In one embodiment, the sunshade may consist of a moving arm connected to a fixed object, which might be a part of the automobile or a part of the sunshade, via a joint which allows the moving arm to move relative to the fixed object in one or more degrees of freedom, a shade material that is connected to the moving arm on one side and the fixed object on the other side such that the relative motion of the moving arm with respect to the fixed object allows the shade material to be deployed or collapsed depending on the motion.

In one variant, the sunshade may contain a moving arm that is telescopic in nature. This may allow the user to adjust the position of the shade in the window opening. In another variant, the sunshade may contain a moving arm that is flexible such that it can bend easily when some force is applied to it and straightens when the force is taken away. This flexibility may allow the sunshade to provide optimal coverage to window openings which are not regular geometrical shapes.

In yet another variant, the sunshade may additionally contain one or more support fingers which are attached to the shade material. The support fingers may provide better coverage by modifying the shape of the deployed shade material.

In yet another variant, the shade material may be specifically constructed with certain structures in it, which guide its deployment and collapse e.g. folds like an accordion.

In yet another variant, the shade material may be a ladder of slats that gets deployed or collapsed during the operation of the sunshade.

In yet another variant, the sunshade may consist of one or more guide strings which are elastic in nature. The guide strings may help with aligning the shade material when the sunshade is closed to prevent the material from interfering with the other moving parts of the sunshade.

In another embodiment, the sunshade may consist of two moving arms, a support bar, a shade material that is connected to the support bar at one end and is connected to a spring roller on the other end. The moving arms may be connected to the opposite sides of a fixed object via a mechanical joint and may be allowed relative movement in one or more degrees of freedom. The two moving arms may be connected to each other using a coupling mechanism such as gear-train or gear belt such that motion caused on one moving arm induces motion on the other moving arm. One end of the support bar may be mounted on the free end of one moving arm and the other end of the support bar may be mounted on the free end of the other moving arm such that the moving arms are allowed to slide along the length of the support bar. The spring roller may be mounted on the fixed object such that rotating it in one direction induces tension because of the internal spring. In the initial rest state, the moving arms are near the fixed object and the spring roller, and the shade material is rolled completely on the spring roller. When the moving arms rotate away from the fixed object, they lift the support bar away from the spring roller, while sliding the mount points towards the ends of the support bar. This causes the shade material to unroll from the spring roller and the shade gets deployed. When the moving arms move towards the fixed object, the mount point slides towards the center of the support bar and moves the support bar towards the spring roller. This motion along with the tension from the spring roller causes the shade material to roll itself on the spring roller. This causes the sunshade to collapse. The sunshade may contain a handle feature that allows a human to operate it manually.

In yet another embodiment, the sunshade may additionally contain a fixed arm to which one or more moving arms are connected via a joint. The fixed arm may also be used to attach one side of the shade material or mount the spring roller. Providing a fixed arm as part of the sunshade allows it to be portable and externally installable.

In yet another embodiment, the sunshade may consist of two moving arms, a fixed arm, two pieces of shade material both in the shape of a quarter of a circle, which may contain folds like an accordion emitting radially outward from the center towards the edge of the circle. One radial edge of one piece of the shade material may be attached to the fixed arm and the other radial edge may be attached to one of the moving arms. One radial edge of the other piece of the shade material may connect to the fixed arm, and the other radial edge may connect to the other moving arm. The circular motion of the moving arm away from the fixed arm causes the shade to the deployed.

In yet another embodiment, the sunshade may consist of two moving arms, a fixed arm, a support bar, the shade material rolled onto a spring roller and a mechanism to allow the moving arms to slide along the length of the fixed arm. The two moving arms are connected, on their one end, to the support bar, via two joints, and the two moving arms are connected, on the opposing end, to two separate sliding caps to form two rotating joints. The sliding caps are mounted on a mechanism which allows them to slide along the length of the fixed arm. When the two sliding caps slide in the opposite direction, the moving arms raise or lower the support bar hence deploying or closing the shade. In one variant, the sunshade may also be operated by using an electro-mechanical system, such as a switch and a motor, which are powered by the automobile electronics.

In another variant, the sunshade may also be operated by a computer program that runs on the automobile's electronics or an externally provided electronic circuit. This program may consider different states of the automobile and environmental factors for operating the sunshade.

In one aspect, a computer program for operating one or more sunshades is disclosed. In one embodiment, the computer program may gather data about the states of the different subsystems within the automobile to operate the sunshade. In one variant, the computer program may gather data about the state of automobile engine. This may allow the computer program to open the sunshade when the engine has stopped running and close the sunshade when the engine start running.

In another variant, the computer program may gather data about the transmission of the automobile. This may allow the computer program to open the sunshade when the user moves the transmission to PARK and to close the sunshade when the transmission is something other than PARK.

In yet another variant, the computer program may gather data about the external lighting conditions, such as light intensity. This may allow the computer program to open the sunshade when it detects presence of external light such as during daytime.

In yet another variant, the computer program may gather data about different automobile subsystems, external lighting conditions, and user input to operate the sunshade. This may allow the computer program to perform optimally under different conditions.

In one aspect, a sunshade system is disclosed which comprises of all the available sunshades in the automobile, which may be operated independently via manual manipulation or electro-mechanical triggers, or via a computer program. The operation of the different sunshades in the system may be dependent on the state of each sunshade in the automobile to provide optimal shading from external sunlight.

In one variant, the operation of the sunshade devices within the sunshade system may be controlled remotely by the user by communicating with each sunshade device directly. The remote user may use a wireless device to communicate with each sunshade device to perform a certain operation such as deployment, and the sunshade device receives the communication and operates accordingly.

In another variant, the operation of the sunshade system may be controlled by the remote user communicating with a computer device, which is a separate entity from the sunshade devices within the sunshade system of the automobile. The remote user may use a wireless device to communicate with the computer device, the computer device then operates one or more sunshade devices according to the communication received.

### BRIEF DESCRIPTION OF THE DRAWINGS

FIGS. 1A-1C are top, side and front views, respectively, of one exemplary fixed arm structure, in accordance with the principles of the present disclosure.

FIGS. 2A-2C are top, side and front views, respectively of one exemplary moving arm structure, in accordance with the principles of the present disclosure.

FIGS. 3A-3D are views of various different shading support structures for use with differing window structures that could be used for controlling the shape of the deployed shade material and for assisting in the deploying or collapsing of the shade material, in accordance with the principles of the present disclosure.

FIG. 4 is a front view of another exemplary shade that has pre-folds similar to an accordion like structure that is utilized in combination with the fixed arm and the moving arm and utilizes a guide string to assist with deployment as well as the collapsing of the shade, in accordance with the principles of the present disclosure.

FIG. 5 is a front view of yet another exemplary shade design, in accordance with the principles of the present disclosure.

FIGS. 6A and 6B are the external view from the side of an automobile showing the front windshield shade from the driver's side with FIG. 6A showing the automobile windshield shade closed and FIG. 6B showing the front automobile windshield shade open, in accordance with the principles of the present disclosure.

FIGS. 7A and 7B are the views from the inside of the automobile of the front windshield shade illustrated in FIG. 5, with FIG. 7A showing the windshield shade when it is closed, and FIG. 7B showing the front windshield shade when it is deployed, in accordance with the principles of the present disclosure.

FIGS. 8A-8C are front views demonstrating another exemplary front windshield shade that uses the support bar structure in a closed, partially open and fully open configuration, in accordance with the principles of the present disclosure.

FIGS. 9A and 9B are various views of another exemplary moving arm structure.

FIG. 9C is the front view of two moving arms illustrated in FIGS. 9A and 9B connected in the center along the length of the moving arms.

FIGS. 10A and 10B are front views demonstrating the windshield shade in partially deployed and fully deployed positions using the moving arm illustrated in FIG. 9A-9C, in accordance with the principles of the present disclosure.

FIG. 11 is an exemplary logical state transition diagram for automatic control of shading system, in accordance with the principles of the present disclosure.

FIGS. 12A-12D are various views showing the construction and operation of an exemplary sunshade device for the window apertures of the automobile doors.

FIGS. 13A-13C are various views of another exemplary moving arm structure with two moving arms, one of which is partially bent along its length, and allows one of the arms to slide along the length of the other arm.

All Figures disclosed herein are © Copyright 2021-2022 Sagar Shah.
All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation or implementations, but other implementations are possible by way of interchange of or combination with some or all of the described or illustrated elements. Wherever convenient, the same reference numbers will be used throughout the drawings to refer to same or like parts.

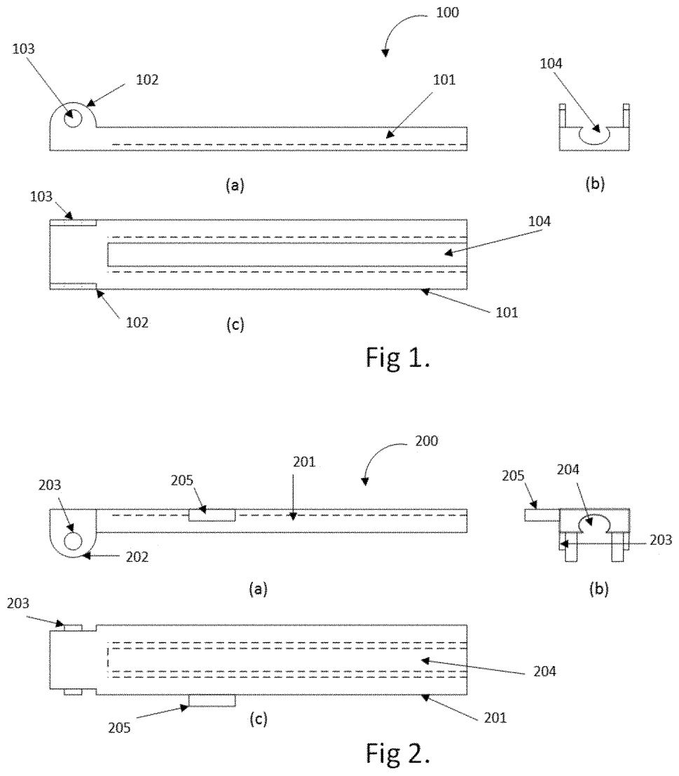

In some implementations, the automobile sunshade may consist of a stationary part, called the fixed arm, which stays fixed or unmoved and contains a feature for allowing a rotating joint where a moving arm can connect and is allowed to rotate with one or more degrees of freedom. This stationary part may not be an explicit part and may be some larger part such as the dashboard of an automobile or the top part of the interior panel of the automobile door. FIG. 1A shows the stationary part 101 as part of a fixed arm 100 containing a joint feature 102. In this example, the joint feature contains an aperture 103 to allow coupling. This present disclosure may also use other types of joints such as a universal joint, a ball-and-socket joint or other types of common joints. The fixed arm contains a ridge like structure 104 along its length that may be used to fix one edge of the shade film. FIG. 1B shows the side view and FIG. 1C shows the top view of the fixed arm 100.

A swivel or moving arm possesses the appropriate coupling features that allows it to connect to the fixed arm via the joint. The arm itself could be of fixed length or could be telescopic to allow its length to vary in order to fit the window opening optimally. The free end may contain more features depending on the application. FIG. 2 shows an example swivel arm 200 that would couple with the fixed arm 100 of FIG. 1. The moving arm 200 contains a joint feature 202 on its one end which contains an axle like structure 204. The moving arm contains a ridge like structure 204 along its length which would be used to fix the other edge of the shade film. The moving arm could also possess a feature similar to a protruding tab 205 which could be used for manually deploying and concealing the shade.

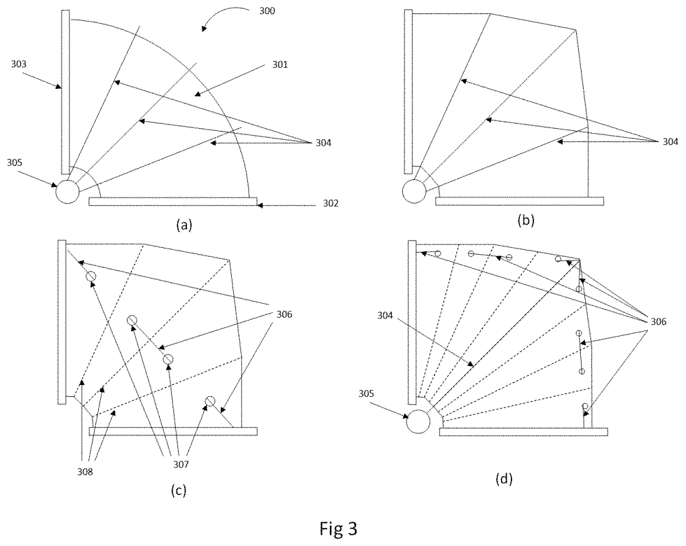

A shade film 301 as shown in FIG. 3A shows the material used for providing the shade and protection against the sun. This material can be reflective, rigid or flexible, malleable, opaque or translucent. A reflective shade material has the advantage of reflecting most of the light away from the vehicle, hence keeping the inside of the vehicle cool. A rigid shade material has the advantage of not needing any support structures in order to retain shade during deployment and concealment. A flexible shade material can stretch to fit different window aperture shapes. Combinations of the foregoing shade materials may be utilized in some implementations. The trailing edge of the shade film is connected to a rod-like structure 302 that gets inserted in the ridge like structure 104 of the fixed arm 100 and the leading edge of the shade film is connected to another rod-like structure 303 that gets inserted in the ridge like structure 204 of the moving arm 200. The film could optionally contain some support structures 304 called support fingers as shown in FIG. 3 to provide support to the film. These support fingers could optionally have a ring like end 305 that could couple with the aperture 103 of the fixed arm structure 100 and the axle 203 of the moving arm 200. These support fingers 300 also allow the film to take other shapes as shown in FIG. 3B.

FIG. 3C shows another embodiment of the film with slightly rigid material which could unfold or fold in an accordion fashion and may not need any support structures. Optionally the film could also be guided by an elastic support line 306 connected between the fixed arm rod like structure 302 and the moving arm rod like structure 303 and interspersed with the folds 308 in the film via specially located holes 307 in the film in order to guide it. The number of holes 307 depend on the number of folds 308 allowed and also depend on the width that shade film will take when it is completely concealed. Increasing the number of holes and hence the folds reduces the width of the folded film but may increase the thickness of the concealed film.

Optionally, the shade films could also comprise of a hybrid structure by adding the support structures 304 to the sunshade assembly 400 such that one instance of the guide string 306 would connect the fixed arm rod like structure 302 to the said support structure 304 and another instance of the guide string would connect the said support structure 304 to the moving arm rod like structure 303 as shown in FIG. 3D.

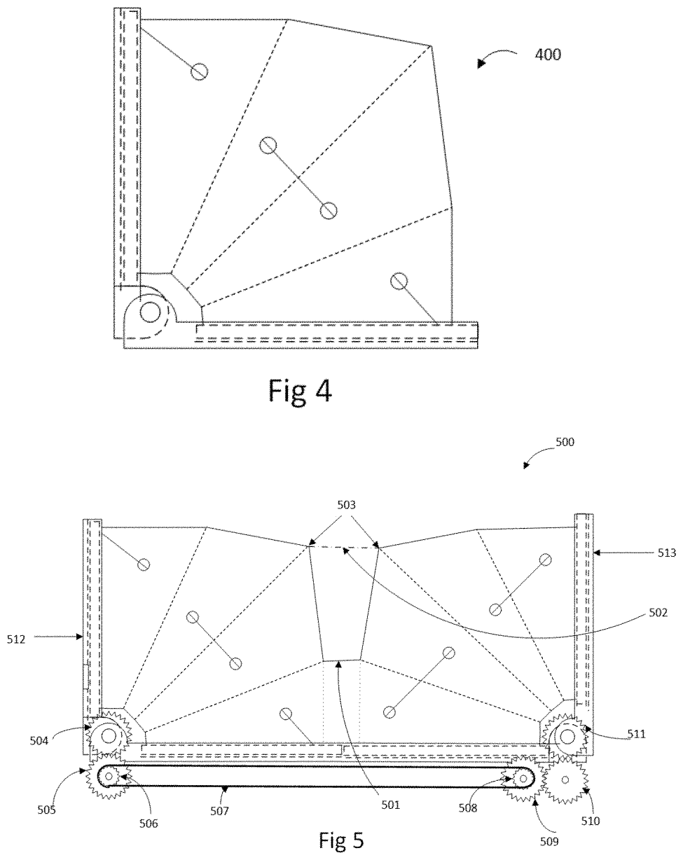

FIG. 4 shows sunshade assembly 400 which shows how the components described in FIGS. 1-3 couple together considering the film of FIG. 3C as an example. The rod-like structures 302, 303 of the film insert into the ridge-like structures 104, 204 of the fixed arm and the moving arm respectively. The axle 203 of the moving arm couples with the aperture 103 of the fixed arm to form the rotating joint. The angle of opening of the rotating joint is only limited by the application.

Optionally, the moving arm 201 may be connected to a motor either directly or via gear trains or other mechanical interconnects in order to achieve electronic operation. The motorization of the moving arm at the joint can be performed in many different ways and will depend on the constraints for implementation. In some implementations, the axle 203 of the moving arm assembly 200 may be keyed or have a shape other than circular to allow the motorized joint to rotate the moving arm. Optionally, the moving arm assembly could possess a keyed aperture and the fixed arm assembly could possess a coupling axle-rod like structure. All possible variations of the joint between the moving arm assembly 200 and the fixed arm assembly 100 are covered by this disclosure.

FIG. 5 shows a combined assembly 500 that can be installed on the dashboard of the automobile for shading the windshield area. This dashboard assembly 500 has been made by joining two sunshade assemblies 400 together by sharing a longer fixed arm and by connecting the shade films together in the middle 501 or optionally near the top 502. Optionally as shown in 500 the interleaving of the guide string with the shade film could be made opposite on the two sides such that, during the opening or closing of the shade film the longest parts 503 of the two shade films fold in opposite directions and do not interfere with each other. The interference could also be solved by operating different sides during opening and closing. For example, during closing left side folds first and then the right side, and during opening, the right side opens first and then the left side.

Additionally, the moving arm 512 may be mechanically coupled with the other moving arm 513 to transfer motion from one arm to the other such that moving one moving arm results in the motion of the other moving arm. FIG. 5 shows one of the embodiments of this mechanical coupling using a gear train and belt drive mechanism as shown 504-511.

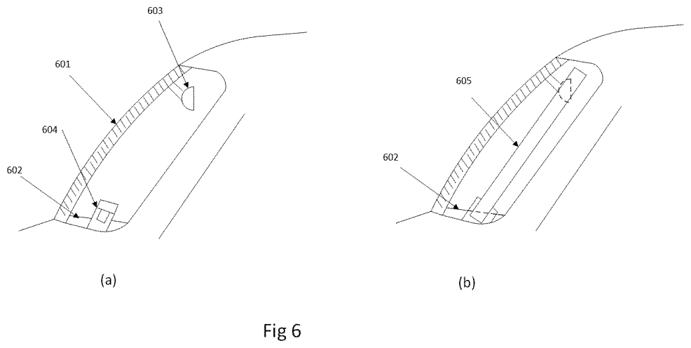

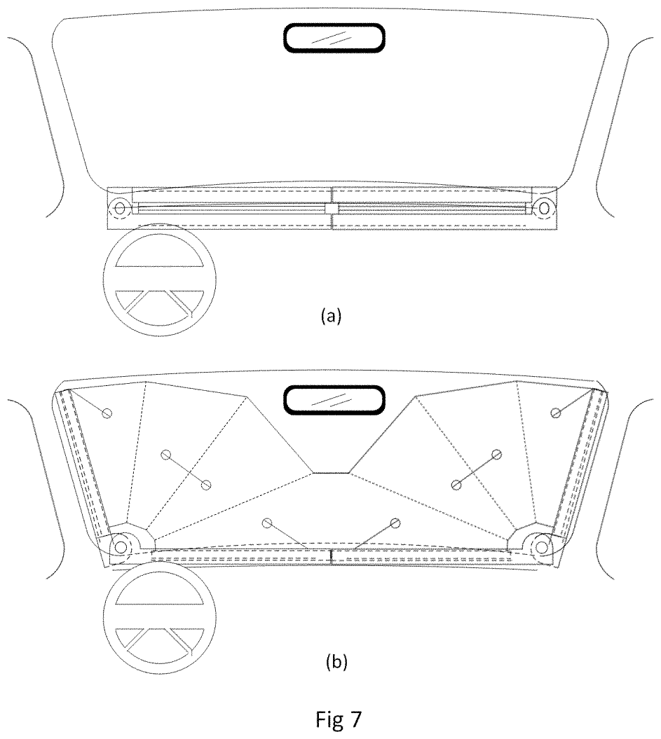

FIG. 6A shows the external side view from the driver's side of the automobile windshield. Usually, the windshields have a slight curvature to them and are installed at a tilt such that the bottom edge of the windshield is farther away from the driver than the top edge. This tilt causes the top edge of the windshield to appear longer than the bottom edge. FIG. 6B shows the same view as FIG. 6A with the sunshade 500 installed and deployed at the same tilt as the windshield.

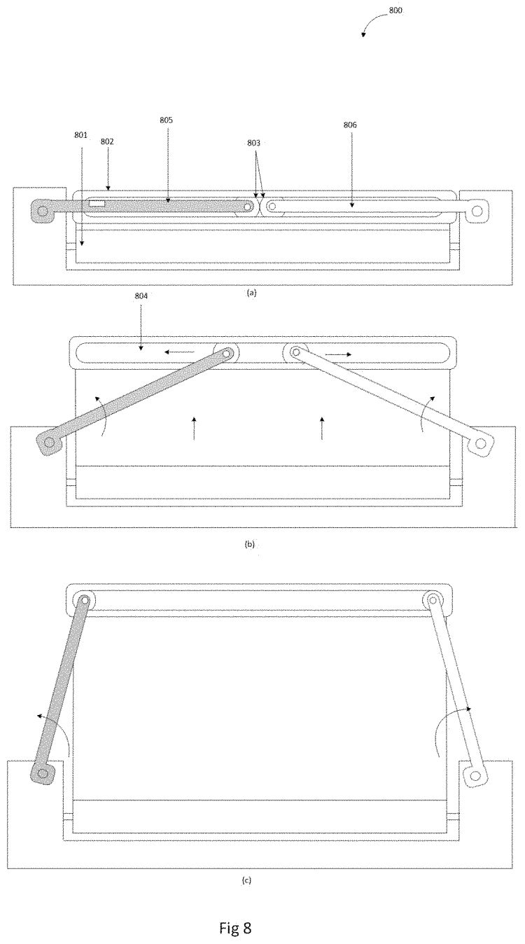

FIG. 7A shows the inside view of the automobile windshield. Note that the top part of the windshield looks wider than the bottom part because of the tilt of the windshield. FIG. 7B shows the same view as FIG. 7A with the sunshade fully deployed at the same tilt as the windshield. The top part of the sunshade appears wider than the bottom part because of the tilt.

FIGS. 8A-8C show another embodiment of the automobile windshield shade wherein the shade material is rolled on a hollow tube with a coiled spring inside, called a spring centered roller 801. One end of the shade material is connected to the roller and the other is connected to a rigid frame 802 which has one or more slots 804 on it to allow the swing arms 805, 806 to connect and slide via a wheel roller 803 or another means for creating a sliding joint between swing arms 805, 806 and the frame 802.. For simplicity, the gear train mechanism connecting the two swing arms is not shown, however is assumed to be present.

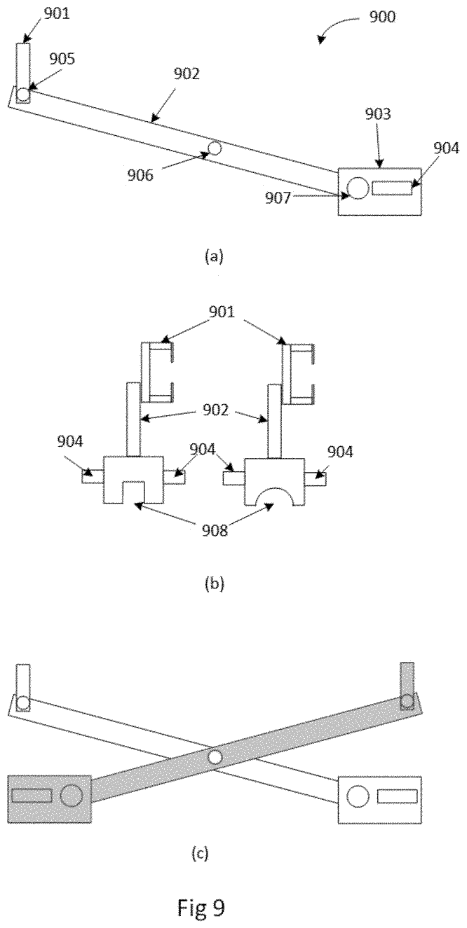

FIG. 9A-9B show another exemplary moving arm structure 900 wherein the moving arm 902 is mounted on a sliding cap 903 on one end to form a rotating joint 907 and is connected to a claw like structure 901 on the other end to form another rotating joint 905. The moving arm 902 has an aperture in the middle to allow forming a rotating joint with another moving arm 902 as illustrated in FIG. 9C. FIG. 9B shows two different versions of the sliding cap with a feature 908 that allows it to connect to belt or a chain or a threaded rod. The sliding cap 903 is shown with exemplary features 904 to prevent sliding cap from rotating around 908. Possible different shapes for feature 908 are shown in FIG. 9B depending on mounting of the sliding cap.

FIG. 9C shows two of the moving arms of FIG. 9A and FIG. 9B connected in the center along their lengths, to form a rotating joint.

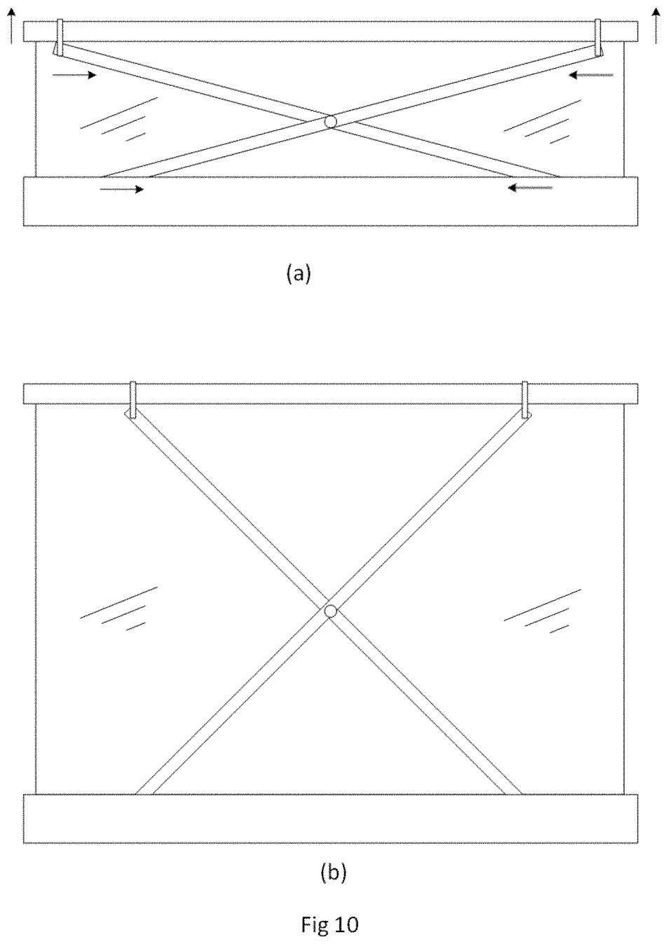

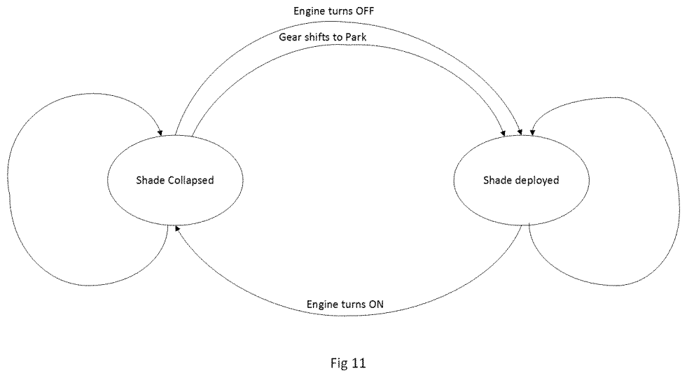

FIGS. 10A and 10B show an exemplary sunshade using the moving arms illustrated in FIGS. 9A-9B, along with the support bar and the shade material in partially deployed and fully deployed positions. As the sliding cap slides towards the center, it causes a rotation of the moving arms relative to itself away from the fixed object, which in turn causes the moving arms to slide on the support bar and move the bar away from the fixed object, causing deployment of the shade.

FIG. 11 shows a simplistic state transition diagram which can be used to create a computer program which reads the engine state and the state of the transmission gear to control the shade deployment. As can be seen, if the shade is deployed then the act of “Engine turns ON” causes the computer program to collapse the shade. And if the shade is collapsed, then either the act of “Engine turns OFF” or the act of “Gear shifts to P” causes the shade to be deployed.

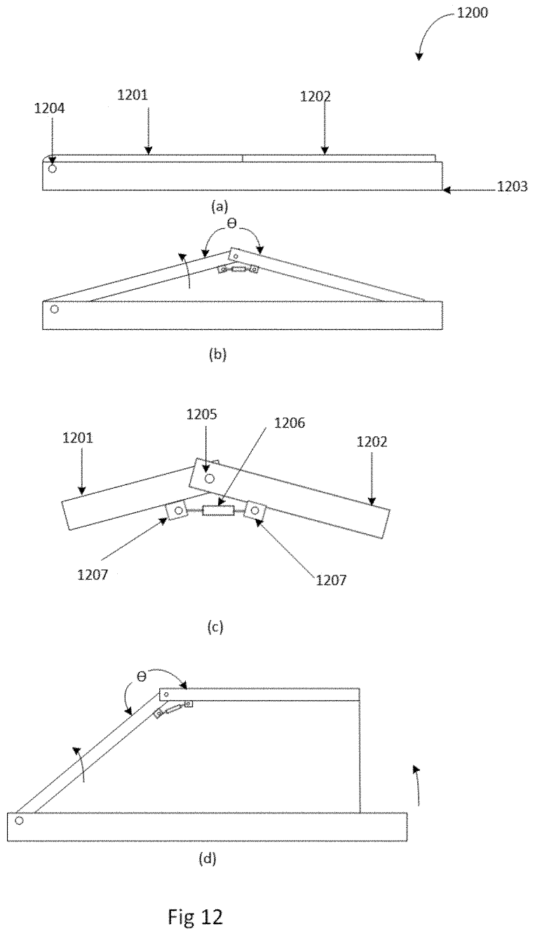

FIG. 12A-12D show an exemplary sunshade device 1200 with a moving arm consisting of two parts 1201 and 1202 and a single point of articulation 1205 along its length that can be used for the window apertures in the automobile door. FIG. 12A shows the sunshade device when it is closed. FIG. 12B shows the sunshade device when it is partially open. The moving has rotated slightly along the joint 1204. The moving arm will generally be allowed to bend at the joint 1205 to some maximum angle θ to fit the shape of the window aperture. FIG. 12C shows a magnified view of an exemplary articulation mechanism, wherein one part of the moving arm 1201 is connected to the other part of the moving arm 1202 via a joint 1205 allowing motion in one or more degrees of freedom. 1201 and 1202 each contain a feature 1207 which allows an element 1206 to be connected such that 1206 is allowed to move in a single degree of freedom. The element 1206 may be able to vary its length within certain limits, to achieve a predetermined angle of rotation θ between 1201 and 1202. FIG. 12D shows the sunshade device in fully deployed position. Note, that the articulation mechanism shown here is only meant to serve as an example and may also cover other types of mechanism such that gear train mechanism, gear chain or gear belt mechanism which may be used between 1204 and 1205, and independent electromechanical mechanisms such as a motor at 1205.

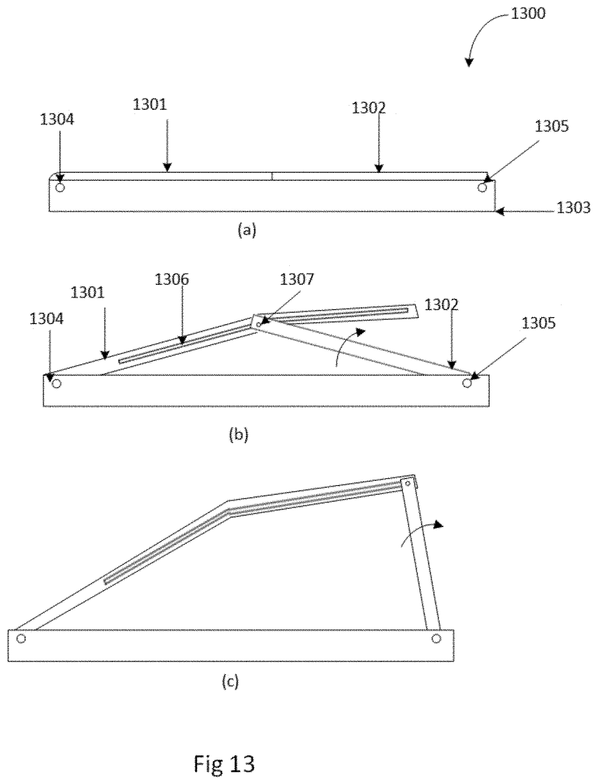

FIGS. 13A-13C show an exemplary sunshade device 1300 with two moving arms 1301 and 1302, which are connected to a fixed object 1303 via the joints 1304 and 1305, respectively. The moving arm 1301 may contain a feature 1306, and the moving arm 1302 may contain a feature 1307, and 1306 and 1307 together create a sliding joint such that the moving arm 1302 can slide along the length of the moving arm 1301 during deployment. Note, that the sliding joint shown here is only meant to serve as an example of the concept and may also cover other mechanisms. FIG. 13A shows the sunshade device in the closed position. FIG. 13B shows the sunshade device in the partial open position. FIG. 13C shows the sunshade device in fully open position.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

What is claimed is:

1. A sunshade device, comprising:
a semi-rigid or pliable shade; and
one or more arms, each of the one or more arms being connected on one end to a fixed object via a joint that allows the one or more arms to rotate freely with respect to the fixed object with one or more degrees of freedom, the one or more arms when rotated apart from the fixed object causing deployment of the semi-rigid or pliable shade.

2. The sunshade device of claim 1, wherein the semi-rigid or pliable shade comprises supporting structures that are attached to or embedded in the semi-rigid or pliable shade, the supporting structures enabling the semi-rigid or pliable shade to conform to a non-linear shape when deployed and guide the semi-rigid or pliable shade to deploy or conceal without interference with moving parts of the sunshade device.

3. The sunshade device of claim 2, wherein at least a portion of the one or more arms or the supporting structures comprises a telescopic arm that enables a given arm or given supporting structure of the one or more arms or supporting structures to change length during the deployment of the semi-rigid or pliable shade.

4. The sunshade device of claim 2, wherein at least a portion of the one or more arms or the supporting structures comprises a flexible arm that enables a given arm or a given supporting structure of the one or more arms or supporting structures to change shape during the deployment of the semi-rigid or pliable shade so as to conform to an irregular geometrical shape.

5. The sunshade device of claim 2, wherein at least a portion of the one or more arms or the supporting structures comprises an arm of the one or more arms or the supporting structures that is able to pivot with respect another arm of the one or more arms or the supporting structures thereby enabling the arm and the other arm to conform to a non-linear shape.

6. The sunshade device of claim 1, wherein an edge of the semi-rigid or pliable shade is directly attached to an arm of the one or more arms, and another edge of the semi-rigid or pliable shade is directly attached to the fixed object, relative motion of the arm with respect to the fixed object causing deployment or concealment of the semi-rigid or pliable shade.

7. The sunshade device of claim 1, wherein the one or more arms comprises two arms connected to the fixed object thereby forming two joints that allows the two arms to rotate freely with respect to the fixed object with one or more degrees of freedom, the two arms being coupled together such that motion caused on one arm induces motion in the other arm; and
the two arms being connected with each other to form a sliding joint that allows one of the two arms to slide freely along the length of another arm of the two arms.

8. The sunshade device of claim 1, wherein the one or more arms comprises two arms connected to the fixed object forming two joints that allows the two arms to rotate freely with respect to the fixed object with one or more degrees of freedom, the two arms being coupled together such that motion caused on one arm induces motion in the other arm; and
the two arms connected on their opposing ends from the two joints to a support bar to form a sliding joint that allows the two arms to slide freely along the length of the support bar.

9. The sunshade device of claim 8, wherein the sun shade device further comprises a spring roller connected to the fixed object or the support bar, with one edge of the semi-rigid or pliable shade connected to the spring roller and another edge of the semi-rigid or pliable shade connected to the fixed object or the support bar that enables the semi-rigid or pliable shade to be deployed by unrolling the semi-rigid or pliable shade from the spring roller when the support bar gets raised as the two arms move apart from the fixed object.

10. The sunshade device of claim 8, wherein the sunshade device comprises a ladder of slats, wherein each of the slats in the ladder of slats are connected to each other using a ladder cord, and the ladder cord is connected to the support bar.

11. A sunshade device, comprising:
two or more movable arms, each of the movable arms connected on one end to a sliding cap to form a joint that allows the two movable arms to rotate freely with a single degree of freedom with respect to the sliding cap;
the sliding cap, mounted on another mechanism that allows the sliding cap to slide.

12. The sunshade device of claim 11, wherein each of the two or more movable arms is connected on another end to a support bar to form a joint that allows the two or more movable arm to rotate with one or more degrees of freedom,

13. The sunshade device of claim 11, wherein the two or more movable arms are connected in the middle of respective ones of the two or more movable arms to each other to form a joint that allows the two or more movable arms to rotate with respect to each other with a single degree of freedom, each of the two or more movable arms connected on another end to a support bar to form a joint that allows the two or more movable arms to slide along a length of the support bar and perform relative rotation with one or more degrees of freedom.

14. The sunshade device of claim 13, further comprising a spring roller connected to the fixed object or the support bar, with one edge of the semi-rigid or pliable shade connected to the spring roller and another edge of the semi-rigid or pliable shade connected to the fixed object or the support bar that enables the semi-rigid or pliable shade to be deployed by unrolling the semi-rigid or pliable shade from the spring roller when the support bar gets raised.

15. The sunshade device of claim 11, further comprising a shade material comprised of a ladder of slats that are connected on a top surface of a support bar and are connected on a bottom of the ladder of slats to a fixed object.

16. A sunshade system, comprising;
one or more sunshades within an automobile, wherein operation of the one or more sunshades may be independent of each other.

17. The sunshade system of claim 16, wherein the one or more sunshades are operated through manual manipulation by a person.

18. The sunshade system of claim 16, wherein the one or more sunshades are manipulated through use of one or more electro-mechanical devices such as switches and motors.

19. The sunshade system of claim 16, wherein a computer program may operate the one or more sunshades within the automobile.

20. The sunshade system of claim 16 wherein the operation of the one or more sunshades is controlled remotely by a user by means of another device.
